(19) United States
(12) Patent Application Publication
(10) Pub. No.: US 2025/0315615 A1
(43) Pub. Date: Oct. 9, 2025

(54) INFORMATION COMPLETION METHOD, METHOD FOR TRAINING INFORMATION COMPLETION MODEL AND RELATED APPARATUS

(71) Applicant: BEIJING BAIDU NETCOM SCIENCE TECHNOLOGY CO., LTD., Beijing (CN)

(72) Inventors: Jiawen Song, Beijing (CN); Chuqing Wang, Beijing (CN); Yunpeng Peng, Beijing (CN)

(73) Assignee: BEIJING BAIDU NETCOM SCIENCE TECHNOLOGY CO., LTD., Beijing (CN)

(21) Appl. No.: 19/238,087

(22) Filed: Jun. 13, 2025

(30) Foreign Application Priority Data
Mar. 20, 2025 (CN) 202510337491.7

(51) Int. Cl. G06F 40/274; G06F 40/284; G06N 20/00

(52) U.S. Cl. CPC G06F 40/274; G06F 40/284; G06N 20/00

(57) ABSTRACT

An information completion method includes: obtaining, for information to be completed, prefix information and suffix information from original input information; obtaining a first candidate token a first direction, a probability of the first candidate token, a second candidate token on a second direction and a probability of the second candidate token, by performing a completion prediction on the information to be completed using a preset information completion model based on the prefix information and the suffix information; determining a target completion direction from the first direction and the second direction based on the probability of the first candidate token and the probability of the second candidate token; and filling a token bit to be filled along the target completion direction with the first candidate token or the second candidate token corresponding to the target completion direction.

### CROSS-REFERENCE TO RELATED APPLICATIONS

The present application is based on and claims the priority of Chinese patent application No. 2025103374917 filed on Mar. 20, 2025, the entire contents of which are incorporated herein by reference.

### TECHNICAL FIELD

The disclosure relates a field of artificial intelligence technologies such as natural language processing, large model and deep learning, in particular to an information completion method, a method for training an information completion model and related apparatuses.

### BACKGROUND

Information completion is an important task in natural language processing. Its purpose is to predict next absent information based on existing information contents, to obtain key information from existing information contents and to complete the existing information.

### SUMMARY

The disclosure provides an information completion method, a method for training an information completion model, related apparatuses, an agent, an electronic device and a storage medium.

According to a first aspect of the disclosure, an information completion method is provided. The method includes:
obtaining, for information to be completed, prefix information and suffix information from original input information;
obtaining a first candidate token used for a completion on a first direction, a probability of the first candidate token, a second candidate token used for the completion on a second direction and a probability of the second candidate token, by performing a completion prediction on the information to be completed using a preset information completion model based on the prefix information and the suffix information, in which a structure of the information completion model is a dual-decoding two-tower information completion deep learning model structure;
determining a target completion direction from the first direction and the second direction based on the probability of the first candidate token and the probability of the second candidate token; and
filling a token bit to be filled along the target completion direction with a candidate token, selected from the first candidate token and the second candidate token, corresponding to the target completion direction.

According to a second aspect of the disclosure, a method for training an information completion model is provided. The method includes:
obtaining training sample data;
obtaining prefix information and suffix information from the training sample data;
obtaining a first candidate token used for a completion on a first direction and a second candidate token used for the completion on a second direction, by inputting the prefix information and the suffix information into the information completion model to perform a completion prediction on the training sample data;
determining a model loss value based on a real token after the prefix information in the training sample data, a real token before the suffix information in the training sample data, the first candidate token and the second candidate token; and
training the information completion model based on the model loss value.

According to a third aspect of the disclosure, an electronic device is provided. The electronic device includes:
at least one processor; and
a memory communicatively connected to the at least one processor;
in which the memory stores instructions executable by the at least one processor, and the instructions are executed by the at least one processor to cause the at least one processor to:
obtain, for information to be completed, prefix information and suffix information from original input information;
obtain a first candidate token used for a completion on a first direction, a probability of the first candidate token, a second candidate token used for the completion on a second direction and a probability of the second candidate token, by performing a completion prediction on the information to be completed using a preset information completion model based on the prefix information and the suffix information, in which a structure of the information completion model is a dual-decoding two-tower information completion deep learning model structure;
determine a target completion direction from the first direction and the second direction based on the probability of the first candidate token and the probability of the second candidate token; and
fill a token bit to be filled along the target completion direction with a candidate token, selected from the first candidate token and the second candidate token, corresponding to the target completion direction

### BRIEF DESCRIPTION OF THE DRAWINGS

The attached drawings are for better understanding the scheme and do not constitute a limitation on the disclosure.

FIG. 1 is a flowchart illustrating an information completion method according to an embodiment of the disclosure.

FIG. 2 is a schematic diagram illustrating a structure of an information completion model according to an embodiment of the disclosure.

FIG. 3 is a flowchart illustrating an information completion method according to an embodiment of the disclosure.

FIG. 4 is a flowchart illustrating a method for training an information completion model according to an embodiment of the disclosure.

FIG. 5 is a block diagram illustrating an information completion apparatus according to an embodiment of the disclosure.

FIG. 6 is a block diagram illustrating an apparatus for training an information completion model according to an embodiment of the disclosure.

FIG. 7 is a block diagram illustrating an agent according to an embodiment of the disclosure.

FIG. 8 is a block diagram illustrating an electronic device used to implement embodiments of the disclosure.

### DETAILED DESCRIPTION

Embodiments of the disclosure will be described below with reference to the accompanying drawings, in which various details of embodiments of the disclosure are included to facilitate understanding, and they should be considered as examples only. Therefore, those skilled in the art should realize that various changes and modifications may be made to embodiments described herein without departing from the scope and spirit of the disclosure. For clarity and brief, descriptions of well-known functions and structures are omitted in the following description.

Embodiments of the disclosure relate to fields of artificial intelligence technologies, such as natural language processing, large model and deep learning.

Artificial intelligence (AI) is a new technical science that studies and develops theories, methods, technologies and application systems for simulating, extending and expanding human intelligence.

Natural language processing (NLP) is an important direction in the fields of computer science and AI. It studies various theories and methods that are capable of realizing effective communication between users and computers using natural language. It is a subject that takes language as an object and uses computer technologies to analyze, understand and process the natural language. That is, it takes computers as powerful tools to study language, conducts quantitative research on language information with the support of computers and provides a language description that may be used by both the users and the computers.

Large language model (LLM), also called large model, refers to a deep learning model trained with a large amount of text data, to generate natural language texts or understand meanings of the language texts. The LLM may handle a variety of natural language tasks, such as text classification, question and answer, dialogue, etc., and is an important tool of AI.

Deep learning is to learn inherent laws and representation levels of sample data, and information obtained in these learning processes is of great help to the interpretation of data such as words, images and sounds. An ultimate goal of the deep learning is to enable machines to have analytical and learning capabilities like human beings to recognize data such as words, images and sounds.

Agent refers to an agent machine that may “perceive” an environment and take actions to achieve a specific goal, which may be software, a hardware or a system with autonomy, adaptability and interactive capabilities. By “perceiving” (for example through sensors or data inputting) changes in the environment, the agent makes judgments and decisions according to knowledge and algorithms learned by itself, and then takes actions to influence the environment or achieve a preset goal.

It is noteworthy that in the technical scheme of the disclosure, the collection, storage, usage, processing, transmission, provision and disclosure of private user information all comply with the provisions of relevant laws and regulations, and do not violate public order and good customs.

It is noteworthy that information (including but not limited to user equipment information, private user information, etc.), data (including but not limited to data for analysis, stored data, displayed data, etc.) and signals involved in the disclosure are all authorized by users or fully authorized by all parties, and the collection, usage and processing of relevant data need to comply with relevant laws, regulations and standards of relevant countries and regions.

It is noteworthy that in embodiments of the disclosure, some existing solutions in industries, such as software, component and model, may be mentioned, which should be regarded as exemplary, and they are brought up only to illustrate the feasibility of implementations of the technical solution of the disclosure, but it does not mean that the applicants have already or necessarily used the solution.

In related arts, model information completion (or Fill-In-the-Middle, FIM) technologies mainly distinguish a prefix and a suffix by signs, and splice the prefix and suffix together to predict information contents in a middle portion (also called holes) along a single direction from front to back. The model structure has the following problems: 1) unified feature encoding without distinguishing semantic differences of contexts; 2) one-way decoding, which can only infer information to be completed from front to back. In fact, for some information, completion from back to front will achieve a higher semantic certainty and is more effective.

In related arts, deep learning models are usually used for information completion. However, the deep learning models used for the information completion in the related arts are usually capable of one-way decoding, resulting in poor semantic prediction performance of the models.

On the basis, embodiments of the disclosure provide an information completion method, a method for training an information completion model and related apparatuses. The completion prediction is performed on the input using the dual-decoding two-tower information completion deep learning model, to obtain output results on two directions, and the direction with a higher certainty may be selected for the information completion based on semantic certainties of the two directions, which may improve the semantic prediction accuracy of the model, and thus the model has a higher applicability in information completion scenarios.

It is noteworthy that the executive subject of the information completion method in embodiments of the disclosure may be an information completion apparatus. The information completion apparatus may be realized by software and/or hardware. The apparatus may be equipped in an electronic device. The electronic device is one selected from a group including, but not limited to, a terminal, a server, and the like.

The information completion method, the method for training an information completion model and related apparatuses according to embodiments of the disclosure will be described below with reference to the accompanying drawings.

FIG. 1 is a flowchart illustrating an information completion method according to an embodiment of the disclosure. As illustrated in FIG. 1, the information completion method includes, but is not limited to, the following.

At block 101, prefix information and suffix information are obtained from original input information for information to be completed.

In some embodiments, the original input information may be information inputted by a user through a terminal. For example, a user interaction interface may be provided for the user, and the user may input information in an input box on the user interaction interface.

In some embodiments, the above information to be completed may be a code to be completed, a text to be completed, etc. That is, the technical solution according to embodiments of the disclosure may be applied to code completion scenarios or text completion scenarios. For example, the technical solution may also be applied to other completion scenarios where middle contents (or called holes) need to be completed using known prefix and suffix.

In some embodiments, the original input information may include a first sign and a second sign for distinguishing a prefix and a suffix. In some examples, the first sign is used for identifying the prefix and the second sign is used for identifying the suffix. In embodiments of the disclosure, the prefix information may be identified for the information to be completed from the original input information by means of the first sign, and the suffix information may be identified for the information to be completed from the original input information by means of the second sign.

In some embodiments, the information completion method according to embodiments of the disclosure may be implemented using an information completion model, which may be a large model by way of example, but is not limited to this. For example, in the case that the information completion model is a large model and a completion service type to which the information to be completed belongs is text completion service, if the information inputted by the user is “please complete contents between “X city” and “scenic spots” to make it a complete sentence”, when receiving the input information, it may be determined from the information inputted by the user based on semantic analysis that the information to be completed is the contents between “X city” and “scenic spots”, in which the prefix information is “X city” and the suffix information is “scenic spots”.

As another example, in the case that the completion service type to which the information to be completed belongs is code completion service, if the information inputted by the user is a code fragment, prefix code information may be obtained from the input code fragment based on a code prefix sign, and suffix code information may be obtained from the input code fragment based on a code suffix sign.

At block 102, a first candidate token used for a completion on a first direction, a probability of the first candidate token, a second candidate token used for the completion on a second direction, and a probability of the second candidate token are obtained by performing a completion prediction on the information to be completed using a preset information completion model based on the prefix information and the suffix information.

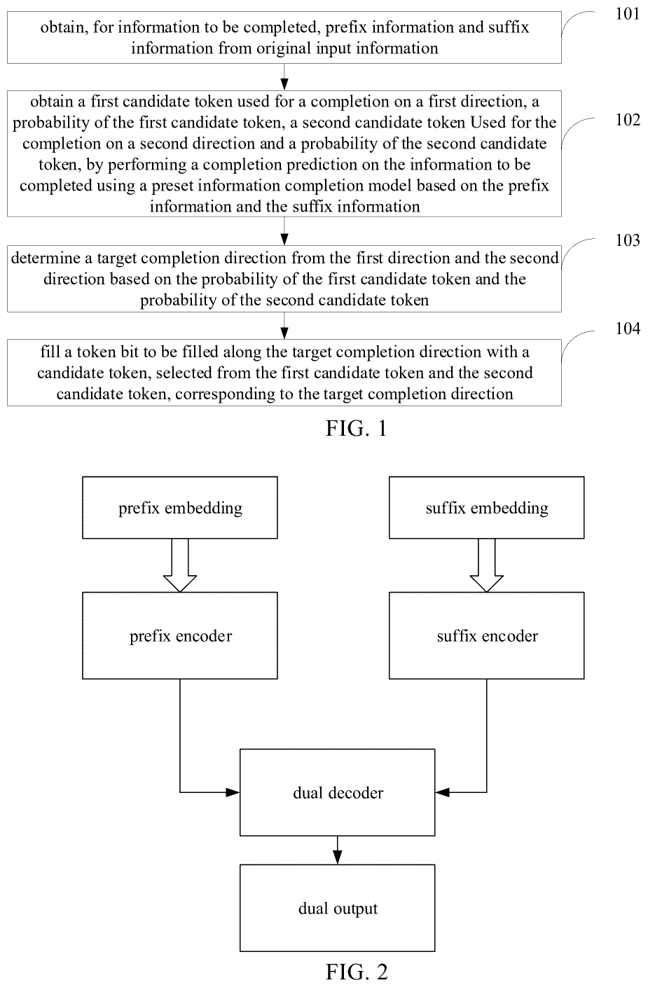

In some embodiments, the network structure of the above information completion model may be a dual-decoding two-tower information completion deep learning model structure. In some embodiments, as illustrated in FIG. 2, the information completion model may include, but is not limited to, a prefix encoder, a suffix encoder and a dual decoder. The network structure of the prefix encoder and the network structure of the suffix encoder are both encoders in a Transformer model, and the dual decoder is a decoder in the Transformer model with the output layer being changed to a dual output layer.

For example, the dual output layer is understood as containing two output layers, such as a first output layer and a second output layer. The first output layer is used to output the first candidate token used for the completion on the first direction and the probability of the first candidate token, and the second output layer is used to output the second candidate token used for the completion on the second direction and the probability of the second candidate token. As an example, the dual output layer may include two Softmax layers, one of which is used to obtain the probability of the first candidate token, represented by probabilities_{prefix}=softmax (output_{prefix}), and the other Softmax layer is used to obtain the probability of the second candidate token, represented by probabilities_{suffix}=softmax(output_{suffix}).

In some embodiments, the first direction is understood as a completion direction from front to back, and the second direction is understood as a completion direction from back to front. Or, in some embodiments, the first direction is understood as a completion direction from back to front, and the second direction is understood as a completion direction from front to back.

In embodiments of the disclosure, the prefix information and the suffix information may be inputted into the information completion model. The inputted prefix information and suffix information are encoded in different directions respectively through the two-tower structure in the information completion model. That is, the prefix information and suffix information are encoded separately. For example, a forward encoding may be performed on the prefix information to obtain a prefix feature, and a backward encoding may be performed on the suffix information to obtain a suffix feature. The prefix feature and the suffix feature may be decoded by the dual decoding mechanism in the information completion model to output the first candidate token used for the completion on the first direction, the probability of the first candidate token, the second candidate token used for the completion on the second direction and the probability of the second candidate token. For example, the forward encoding may be used to encode the prefix information, to deeply analyze the prefix into the prefix feature through calculation. The backward encoding may be used to encode the suffix information to deeply analyze the suffix into the suffix feature through calculation. The “dual decoding” refers to a deep decoding by performing a comprehensive calculation on the prefix feature and the suffix feature to output probabilities of two tokens that are used for forward and backward completions respectively.

At block 103, a target completion direction is determined from the first direction and the second direction based on the probability of the first candidate token and the probability of the second candidate token.

In embodiments of the disclosure, the completion direction is selected from the first direction and the second direction based on the probability of the first candidate token and the probability of the second candidate token, and the selected completion direction is determined as the target completion direction.

In some embodiments, the probability of the first candidate token is compared with the probability of the second candidate token. In response to the probability of the first candidate token being greater than the probability of the second candidate token, the first direction is determined as the target completion direction. Or, in response to the probability of the second candidate token being greater than the probability of the first candidate token, the second direction is determined as the target completion direction. For example, in the case that the first direction is from front to back and the second direction is from back to front, if the probability of the first candidate token is greater than the probability of the second candidate token, the first direction (i.e., from front to back, which is also called forward completion direction) is determined as the target completion direction. If the probability of the second candidate token is greater than the probability of the first candidate token, the second direction (i.e., from back to front, which is also called backward completion direction) is determined as the target completion direction.

That is, based on the probability of the first candidate token used for the completion on the first direction and the probability of the second candidate token used for the completion on the second direction, a direction with a higher semantic certainty may be selected from the two directions based on semantic certainties of the two directions as the target completion direction.

In some embodiments, in response to the probability of the first candidate token being equal to the probability of the second candidate token, the first direction and/or the second direction may be determined as the target completion direction. For example, if the probability of the first candidate token is equal to the probability of the second candidate token, any one of the first direction or the second direction may be determined as the target completion direction. That is, the first direction may be determined as the target completion direction, or the second direction may be determined as the target completion direction. Or, for example, if the probability of the first candidate token is equal to the probability of the second candidate token, both the first direction and the second direction are determined as the target completion directions. In this way, the prediction efficiency of the model may be further improved.

At block 104, a token bit to be filled is filled along the target completion direction with a candidate token, selected from the first candidate token and the second candidate token, corresponding to the target completion direction.

In embodiments of the disclosure, after the target completion direction is determined, the candidate token corresponding to the target completion direction is filled in the token bit to be filled along the target completion direction.

In above embodiments, by performing the completion prediction on the input using the dual-decoding two-tower information completion deep learning model, output results on two directions are obtained, and the direction with a higher semantic certainty may be selected for the information completion based on the semantic certainties of the two directions, which may improve the semantic prediction accuracy of the model, and thus the model has a higher applicability in information completion scenarios.

In some embodiments, when the target completion direction is the first direction, the hole(s) is/are filled with the first candidate token along the first direction. For example, taking the first direction is from front to back as an example, if the target completion direction is the first direction, the token bit(s) to be filled (i.e., the middle portion or the holes) after the prefix information is/are filled with the first candidate token along the first direction. For example, if the prefix information is “X city” and the suffix information is “scenic spots”, assuming that the first candidate token is “has”, the second candidate token is “a/an” and the target completion direction is the first direction (such as from front to back), then the token bit to be filled after the prefix information is filled with the first candidate token “has”, to obtain the information “X city has”.

In some embodiments, when the target completion direction is the second direction, the hole(s) is/are filled with the second candidate token along the second direction. For example, taking the second direction is from back to front as an example, if the target completion direction is the second direction, the token bit(s) to be filled before the suffix information is/are filled with the second candidate token along the second direction. For example, if the prefix information is “X city” and the suffix information is “scenic spots”, assuming that the first candidate token is “has”, the second candidate token is “natural” and the target completion direction is the second direction (such as from back to front), then the token bit to be filled before the suffix information of “scenic spots” may be filled with the second candidate token “natural” to obtain “natural scenic spots”.

In some embodiments, when the first direction and the second direction are both determined as the target completion directions, the hole(s) may be filled with the first candidate token along the first direction, and the hole(s) may be filled with the second candidate token along the second direction. For example, the first direction is the direction of completion from front to back and the second direction is the direction of completion from back to front, if the first direction and the second direction are both determined as the target completion directions, the token bit(s) to be filled after the prefix information is/are filled with the first candidate token along the first direction, and the token bit(s) to be filled before the suffix information is/are filled with the second candidate token along the second direction. For example, if the prefix information is “X city” and the suffix information is “scenic spots”, assuming that the first candidate token is “has”, the second candidate token is “natural”, and the first direction (such as the direction from the back to the front) and the second direction (such as the direction from the back to the front) are both determined as the target completion directions, then the token bit to be filled after the prefix information “X city” is filled with the first candidate token “has”, and the token bit to be filled before the suffix information “scenic spots” is filled with the second candidate token “natural”, to obtain “X city has natural scenic spots”.

It is noteworthy that in the process of performing the information completion with the information completion model, the information completion model may stop generating more information if a completion prediction end condition is met. If the completion prediction end condition is not met, the information completion model continues to perform the prediction on a next token bit to be filled to generate more contents.

It is worth noting that when performing the prediction on the next token bit to be filled, the prefix information and/or suffix information to be inputted to the model needs to be updated, to facilitate the completion prediction based on the updated input. In some embodiments, when the target completion direction is the first direction, after the corresponding token bit to be filled is filled with the first candidate token, the suffix information may be kept unchanged, and the prefix information together with the filled first candidate token (such as a combination of the prefix information and the filled first candidate token) are taken as new prefix information. Then the prediction is performed on the next token bit(s) to be filled based on the new prefix information and the suffix information. For example, the new prefix information and the suffix information are inputted into the information completion model for the completion prediction.

In some embodiments, when the target completion direction is the second direction, after the corresponding token bit to be filled is filled with the second candidate token, the prefix information may be kept unchanged, and the suffix information together with the filled second candidate token (such as a combination of the suffix information and the filled second candidate token) are taken as the new suffix information. Then the prediction is performed on the next token bit(s) to be filled based on the prefix information and the new suffix information. For example, the new suffix information and the prefix information are input into the information completion model for the completion prediction.

In some embodiments, when the first direction and the second direction are both determined as the target completion directions, after the corresponding token bits to be filled are filled with the first candidate token and the second candidate token respectively, the prefix information together with the filled first candidate token (such as a combination of the prefix information and the filled first candidate token) are taken as new prefix information, and the suffix information together with the filled second candidate token (such as a combination of the suffix information and the filled second candidate token) are taken as new suffix information. Then, the prediction is performed on next token bit(s) to be filled based on the new prefix information and the new suffix information. For example, the new prefix information and the new suffix information are inputted into the information completion model for the completion prediction.

If the completion prediction end condition is not met, the information completion model may continue to predict until the completion prediction end condition is met, and then the information completion model may stop generating more information. For example, the completion prediction end condition may include at least one of that: generated information to be completed reaches a preset maximum length; a specific end symbol is encountered; a preset number of rounds of generation is reached; or a reasonable end condition is detected (for example, taking the code completion as an example, when the information completion model determines that the definition of a function or a method has been completed, it will stop generating more codes).

In some embodiments, after the token bit(s) to be filled between the prefix information and the suffix information has/have been filled to obtain completed information, a token that meets a removal condition in the completed information is removed. The removal condition is determined based on a pre-configuration and/or the original input information. For example, when inputting information, the user may set the removal condition in the original input information, or the user may pre-configure the removal condition, e.g., pre-configuring characters or symbols that need to be removed. On the basis, after the token bits to be filled between the prefix information and suffix information have been filled, the tokens that meet the removal condition may be removed from the completed information, which may improve the effect of information completion and also improve the accuracy of information completion.

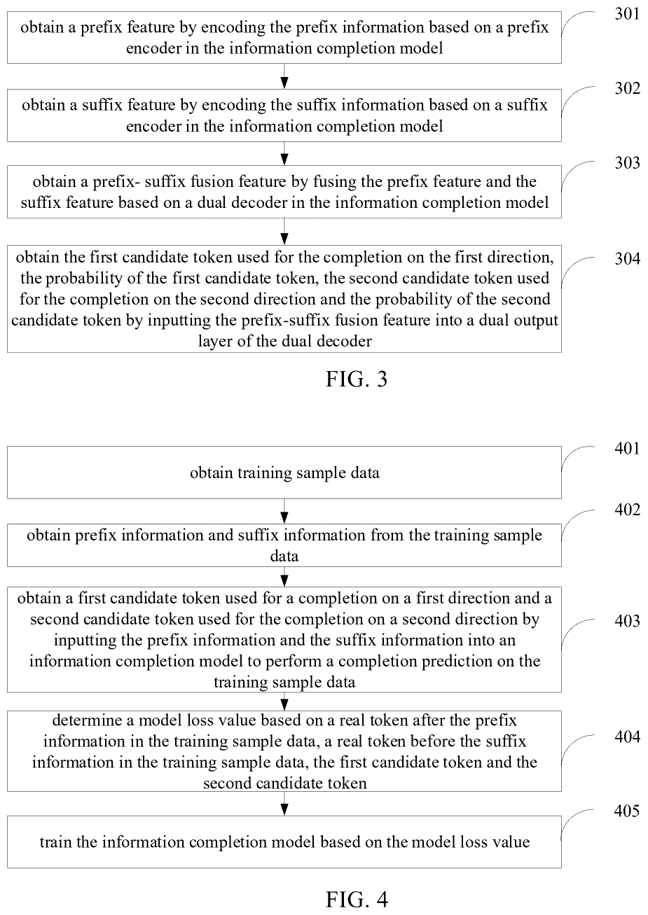

FIG. 3 is a flowchart illustrating an information completion method according to an embodiment of the disclosure. On the basis of FIG. 1, as illustrated in FIG. 3, one possible way to obtain the first candidate token used for the completion on the first direction, the probability of the first candidate token, the second candidate token used for the completion on the second direction and the probability of the second candidate token, by performing the completion prediction on the information to be completed using the preset information completion model based on the prefix information and the suffix information includes the following.

At block 301, a prefix feature is obtained by encoding the prefix information based on a prefix encoder in the information completion model.

For example, the network structure of the prefix encoder is an encoder in the Transformer model. The encoder may process the prefix information to obtain an embedding representation of the prefix information, and use a self-attention mechanism to perform a feature extraction on the embedding representation of the prefix information to obtain the prefix feature. The encoder is composed of multiple layers, and each layer has two main parts: one is a multi-head self-attention mechanism, which allows the model to take into account other words in a sequence when processing a word in the sequence and capture a relationship therebetween, and the other is a feed forward neural network, which may further process an output of an attention layer.

At block 302, a suffix feature is obtained by encoding the suffix information based on a suffix encoder in the information completion model.

For example, the network structure of the suffix encoder is an encoder in the Transformer model. The encoder may process the suffix information to obtain an embedding representation of the suffix information, and use a self-attention mechanism to perform a feature extraction on the embedding representation of the suffix information, to obtain the suffix feature. The structure of the encoder is the same as that of the encoder described in the block 301 above, which will not be described here.

At block 303, a prefix-suffix fusion feature is obtained by fusing the prefix feature and the suffix feature based on a dual decoder in the information completion model.

For example, the dual decoder may be a decoder in the Transformer model, but the output layer of the decoder is changed to a dual output layer. The dual decoder may fuse the prefix feature and the suffix feature.

At block 304, the first candidate token used for the completion on the first direction, the probability of the first candidate token, the second candidate token used for the completion on the second direction, and the probability of the second candidate token are obtained by inputting the prefix-suffix fusion feature into a dual output layer of the dual decoder.

For example, the dual output layer consists of two Softmax layers, one of which is used to obtain the probability of the first candidate token, which is represented by probabilities_{prefix}=softmax(output_{prefix}), and the other Softmax layer is used to obtain the probability of the second candidate token, which is represented by probabilities_{suffix}=softmax(output_{suffix}). The dual output layer obtains two output results, one of which is the first candidate token used for the completion on the first direction and the probability of the first candidate token, and the other output result is the second candidate token used for the completion on the second direction and the probability of the second candidate token.

Therefore, with the completion prediction performed on the input using the dual-decoding two-tower information completion deep learning model, the feature encoding may be performed separately on the prefix information and suffix information, and the output results on two directions may be obtained in the decoding stage. The direction with a higher semantic certainty may be selected for the information completion based on semantic certainties of the two directions, which may improve the semantic prediction accuracy of the model.

FIG. 4 is a flowchart illustrating a method for training an information completion model according to an embodiment of the disclosure. As illustrated in FIG. 4, the method includes the following.

At block 401, training sample data is obtained.

For example, the training sample data may be, but is not limited to, a text sample or a code sample.

At block 402, prefix information and suffix information are obtained from the training sample data.

For example, the implementation of obtaining the prefix information and suffix information from the training sample data may refer to the description of related embodiments in the block 101 in FIG. 1, which is not repeated here.

At block 403, a first candidate token used for a completion on a first direction and a second candidate token used for the completion on a second direction are obtained by inputting the prefix information and the suffix information into an information completion model to perform a completion prediction on the training sample data.

For example, the structure and function of the information completion model may refer to the description of related embodiments in the block 102 in FIG. 1, which will not be repeated here.

At block 404, a model loss value is determined based on a real token after the prefix information in the training sample data, a real token before the suffix information in the training sample data, the first candidate token and the second candidate token.

In some embodiments, a first loss value is determined based on the real token after the prefix information in the training sample data and the first candidate token. A second loss value is determined based on the real token before the suffix information in the training sample data and the second candidate token. The model loss value is determined based on the first loss value and the second loss value. For example, the model loss value may be obtained by a preset loss function. For example, the loss function may be, but is not limited to, a cross entropy loss function. For example, when the first loss value and the second loss value are obtained, the first loss value and the second loss value may be added to obtain the model loss value. Or, the first loss value and the second loss value may be weighted and then summed up to obtain the model loss value.

At block 405, the information completion model is trained based on the model loss value.

For example, parameters of the information completion model may be modified based on the model loss value until a training end condition is met. The training end condition includes that the model loss value is less than a preset loss threshold, or a number of training iterations reaches a preset number.

In above embodiments, through training the dual-decoding two-tower information completion deep learning model, the feature encoding may be performed separately on the prefix information and suffix information, and the output results on two directions may be obtained in the decoding stage. The direction with a higher semantic certainty may be selected for the information completion based on semantic certainties of the two directions, which may improve the semantic prediction accuracy of the model, and thus the model has a higher applicability in information completion scenarios.

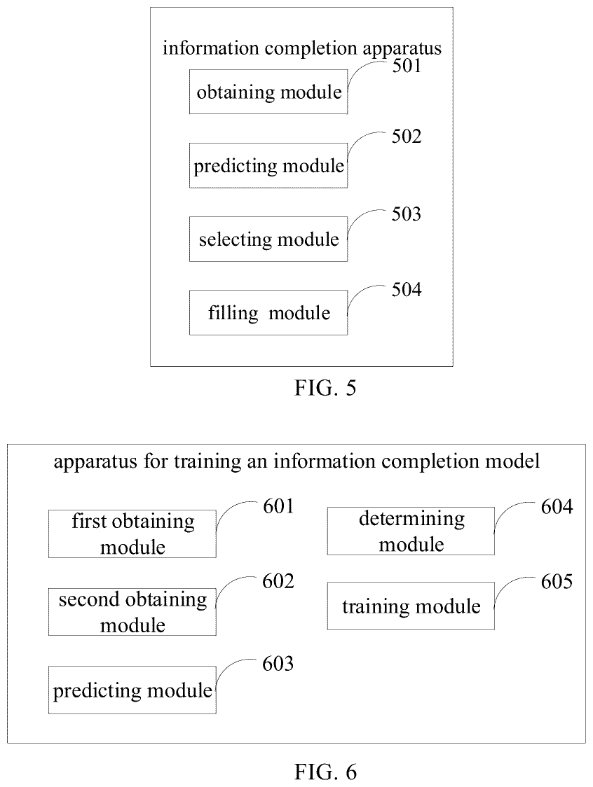

FIG. 5 is a block diagram illustrating an information completion apparatus according to an embodiment of the disclosure. As illustrated in FIG. 5, the information completion apparatus includes: an obtaining module 501, a predicting module 502, a selecting module 503, and a filling module 504.

The obtaining module 501 is configured to obtain, for information to be completed, prefix information and suffix information from original input information.

The predicting module 502 is configured to obtain a first candidate token used for a completion on a first direction, a probability of the first candidate token, a second candidate token used for the completion on a second direction and a probability of the second candidate token, by performing a completion prediction on the information to be completed using a preset information completion model based on the prefix information and the suffix information, in which a structure of the information completion model is a dual-decoding two-tower information completion deep learning model structure.

The selecting module 503 is configured to determine a target completion direction from the first direction and the second direction based on the probability of the first candidate token and the probability of the second candidate token.

The filling module 504 is configured to fill a hole along the target completion direction, with a candidate token, selected from the first candidate token and the second candidate token, corresponding to the target completion direction.

In some embodiments, the predicting module 502 is configured to obtain a prefix feature by encoding the prefix information based on a prefix encoder in the information completion model; obtain a suffix feature by encoding the suffix information based on a suffix encoder in the information completion model; obtain a prefix-suffix fusion feature by fusing the prefix feature and the suffix feature based on a dual decoder in the information completion model; and obtain the first candidate token used for the completion on the first direction, the probability of the first candidate token, the second candidate token used for the completion on the second direction and the probability of the second candidate token by inputting the prefix-suffix fusion feature into a dual output layer of the dual decoder.

In some embodiments, the selecting module 503 is configured to compare the probability of the first candidate token with the probability of the second candidate token; in response to the probability of the first candidate token being greater than the probability of the second candidate token, determine the first direction as the target completion direction; or in response to the probability of the second candidate token being greater than the probability of the first candidate token, determine the second direction as the target completion direction; or in response to the probability of the first candidate token being equal to the probability of the second candidate token, determine the first direction and/or the second direction as the target completion direction.

In some embodiments, the filling module 504 is configured to, in response to the target completion direction being the first direction, fill a token bit to be filled after the prefix information along the first direction with the first candidate token; or, in response to the target completion direction being the second direction, fill a token bit to be filled before the suffix information along the second direction with the second candidate token; or, in response to the target completion direction including the first direction and the second direction, fill the token bit to be filled after the prefix information along the first direction with the first candidate token, and fill the token bit to be filled before the suffix information along the second direction with the second candidate token.

In some embodiments, the predicting module 502 is configured to, in response to the target completion direction being the first direction, after filling a corresponding token bit to be filled with the first candidate token, keep the suffix information unchanged, take a combination of the prefix information and the filled first candidate token as new prefix information, and perform a prediction on a next token bit to be filled based on the new prefix information and the suffix information; or, in response to the target completion direction being the second direction, after filling a corresponding token bit to be filled with the second candidate token, keep the prefix information unchanged, take a combination the suffix information and the filled second candidate token as new suffix information, and perform a prediction on a next token bit to be filled based on the new suffix information and the prefix information; or, in response to the target completion direction including the first direction and the second direction, after filling corresponding token bits to be filled with the first candidate token and the second candidate token respectively, take a combination of the prefix information and the filled first candidate token as new prefix information, take a combination of the suffix information and the filled second candidate token as new suffix information, and perform a prediction on a next token bit to be filled based on the new prefix information and the new suffix information.

In some embodiments, the apparatus further includes: a removing module. The removing module is configured to, after the token bits to be filled between the prefix information and the suffix information are filled to obtain completed information, remove a token that meets a removal condition in the completed information, in which the removal condition is determined based on a pre-configuration and/or the original input information.

Regarding the apparatus in above-mentioned embodiments, the specific way in which each module performs an operation has been described in detail in method embodiments, which will not be described in detail here.

FIG. 6 is a block diagram illustrating an apparatus for training an information completion model according to an embodiment of the disclosure. As illustrated in FIG. 6, the apparatus may include: a first obtaining module 601, a second obtaining module 602, a predicting module 603, a determining module 604, and a training module 605.

The first obtaining module 601 is configured to obtain training sample data.

The second obtaining module 602 is configured to obtain prefix information and suffix information from the training sample data.

The predicting module 603 is configured to obtain a first candidate token used for a completion on a first direction and a second candidate token used for the completion on a second direction by inputting the prefix information and the suffix information into an information completion model to perform a completion prediction on the training sample data, in which a structure of the information completion model is a dual-decoding two-tower information completion deep learning model structure.

The determining module 604 is configured to determine a model loss value based on a real token after the prefix information in the training sample data, a real token before the suffix information in the training sample data, the first candidate token and the second candidate token.

The training module 605 is configured to train the information completion model based on the model loss value.

In some embodiments, the determining module 604 is configured to determine a first loss value based on the real token after the prefix information in the training sample data and the first candidate token; determine a second loss value based on the real token before the suffix information in the training sample data and the second candidate token; and determine the model loss value based on the first loss value and the second loss value.

In some embodiments, the information completion model at least includes: a prefix encoder, a suffix encoder and a dual decoder. Network structures of the prefix encoder and the suffix encoder are both encoders in a Transformer model, the dual decoder is a decoder in the Transformer model with the output layer being changed to a dual output layer.

Regarding the apparatus in above-mentioned embodiments, the specific way in which each module performs an operation has been described in detail in method embodiments, which will not be described in detail here.

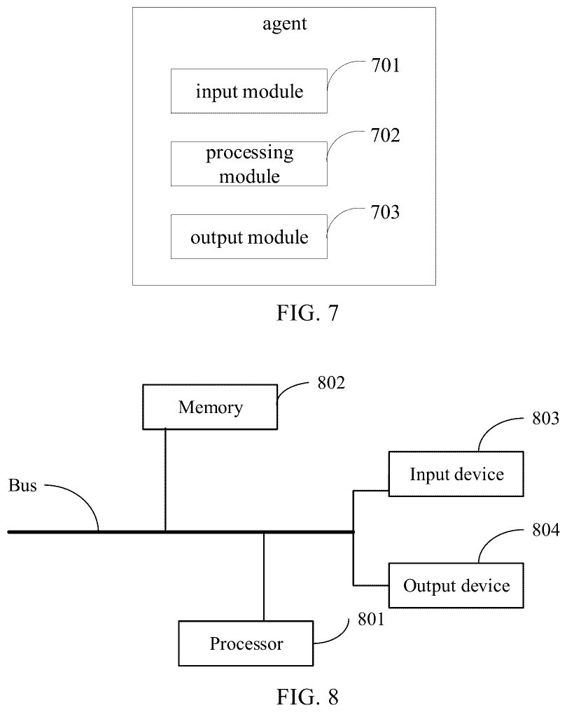

FIG. 7 is a block diagram illustrating an agent according to an embodiment of the disclosure. As illustrated in FIG. 7, the agent includes: an input module 701, a processing module 702, and an output module 703. The input module 701 is configured to receive input information. The processing module 702 is configured to determine a target task based on the input information received by the input module, determine an information completion model based on the target task, and obtain output information by calling the information completion model to perform the information completion method or the method for training an information completion model described in embodiments of the disclosure. The output module 703 is configured to output the output information obtained by the processing module. For example, the information completion model may be a large model, which it is not limited here.

According to embodiments of the disclosure, the disclosure also provides an electronic device and a readable storage medium.

FIG. 8 is a block diagram illustrating an electronic device according to an embodiment of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown here, their connections and relations, and their functions are merely examples, and are not intended to limit the implementations of the disclosure described and/or required herein.

As illustrated in FIG. 8, the electronic device includes: one or more processors 801, a memory 802, and interfaces for connecting various components, including a high-speed interface and a low-speed interface. The various components are interconnected using different buses and may be mounted on a common mainboard or otherwise installed as required. The processor may process instructions executed within the electronic device, including instructions stored in or on the memory to display graphical information of the GUI on an external input/output device such as a display device coupled to the interface. In other implementations, a plurality of processors and/or buses may be used with a plurality of memories and processors, if desired. Similarly, a plurality of electronic devices may be connected, each providing some of the necessary operations (for example, as a server array, a group of blade servers, or a multiprocessor system). For example, in FIG. 8, there is only one processor 801.

The memory 802 is a non-transitory computer readable storage medium according to the disclosure. The memory stores instructions executable by at least one processor, which may be used to cause the at least one processor to perform the information completion method or the method for training an information completion model according to the disclosure. The non-transitory computer readable storage medium in the disclosure stores computer instructions, which are used to cause a computer to perform the information completion method or the method for training an information completion model according to the disclosure.

As a non-transitory computer readable storage medium, the memory 802 may be used to store non-transitory software programs, non-transitory computer executable programs and modules, such as program instructions/modules corresponding to the information completion method or the method for training an information completion model in the embodiment of the disclosure, including the obtaining module 501, the predicting module 502, the selecting module 503 and the filling module 504 shown in FIG. 5, and the first obtaining module 601, the second obtaining module 602, the predicting module 603, the determining module 604 and the training module 605. The processor 801 executes various functional applications and data processing of the server by running non-transitory software programs, instructions and modules stored in the memory 802, i.e., implementing the information completion method or the method for training an information completion model in the above method embodiments.

The memory 802 includes a program storage area and a data storage area. The program storage area stores an operating system and application programs required by at least one function. The data storage area stores data created according to the use of electronic device and the like. In addition, the memory 802 may include a high-speed random access memory and a non-transitory memory, such as at least one disk memory, a flash memory, or other non-transitory solid memories. In some embodiments, optionally, the memory 802 may include memories arranged far from the processor 801, and these remote memories may be connected to the electronic device through a network. Examples of the above networks include, but are not limited to, the Internet, an intranet, a local area network, a mobile communication network, and any combinations thereof.

The electronic device may also include an input device 803 and an output device 804. The processor 801, the memory 802, the input device 803 and the output device 804 are connected by a bus or by other means. For example, they are connected by buses as shown in FIG. 8.

The input device 803 may receive input digital or character information and generate key signal input related to user settings and function control of electronic device, such as touch screen, keypad, mouse, track pad, touch pad, pointing stick, one or more mouse buttons, trackball, joystick and other input devices. The output device 804 may include a display device, an auxiliary lighting device (for example, a light emitting diode (LED)), a tactile feedback device (for example, a vibration motor), and the like. The display device may include, but is not limited to, a liquid crystal display (LCD), an LED display and a plasma display. In some implementations, the display device may be a touch screen.

Various embodiments of the systems and techniques described herein may be implemented in a digital electronic circuit system, an integrated circuit system, an application specific integrated circuit (ASIC), a computer hardware, firmware, software and/or combinations thereof. These various implementation may be implemented in one or more computer programs, which may be executed and/or interpreted on a programmable system including at least one programmable processor. The programmable processor may be a special-purpose or general programmable processor, which may receive data and instructions from a storage system, at least one input device and at least one output device, and transmit the data and instructions obtained from the storage system, the at least one input device, and the at least one output device.

These computing programs (also referred to as programs, software, software applications, or codes) include machine instructions for a programmable processor and may be implemented using high-level procedural and/or object-oriented programming languages, and/or assembly/machine languages. As used herein, the terms “machine-readable medium” and “computer-readable medium” refer to any computer program product, device and/or apparatus (e.g., disk, Compact Disc Read-Only Memories (CD-ROM), memory, Programmable Logic Device (PLD)) used to provide machine instructions and/or data to a programmable processor, including machine-readable medium that receives machine instructions as machine-readable signals. The term “machine-readable signal” refers to any signal used to provide machine instructions and/or data to the programmable processor.

In order to provide interaction with a user, the systems and techniques described herein may be implemented on a computer having a display device (e.g., a Cathode Ray Tube (CRT) or a Liquid Crystal Display (LCD) monitor) for displaying information to a user, and a keyboard and pointing device (such as a mouse or trackball) through which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes back-end components (for example, a data server), or a computing system that includes middleware components (for example, an application server), or a computing system that includes front-end components (for example, a user computer with a graphical user interface or a web browser, through which the user may interact with the implementations of the systems and technologies described herein), or a computing system that includes any combination of such back-end components, middleware components and front-end components. The components of the system may be interconnected by any form or medium of digital data communication (e.g., a communication network). Examples of communication networks include: a Local Area Network (LAN), a Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and Virtual Private Server (VPS) services. The server may be a server of a distributed system, or a server combined with a block-chain.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

What is claimed is:

1. An information completion method, comprising:
obtaining, for information to be completed, prefix information and suffix information from original input information;
obtaining a first candidate token used for a completion on a first direction, a probability of the first candidate token. a second candidate token used for the completion on a second direction and a probability of the second candidate token, by performing a completion prediction on the information to be completed using a preset information completion model based on the prefix information and the suffix information, wherein a structure of the information completion model is a dual-decoding two-tower information completion deep learning model structure;
determining a target completion direction from the first direction and the second direction based on the probability of the first candidate token and the probability of the second candidate token; and
filling a token bit to be filled along the target completion direction with a candidate token, selected from the first candidate token and the second candidate token, corresponding to the target completion direction.

2. The method of claim 1, wherein obtaining the first candidate token used for the completion on the first direction, the probability of the first candidate token, the second candidate token used for the completion on the second direction and the probability of the second candidate token by performing the completion prediction on the information to be completed using the preset information completion model based on the prefix information and the suffix information, comprises:
obtaining a prefix feature by encoding the prefix information based on a prefix encoder in the information completion model;
obtaining a suffix feature by encoding the suffix information based on a suffix encoder in the information completion model;
obtaining a prefix-suffix fusion feature by fusing the prefix feature and the suffix feature based on a dual decoder in the information completion model; and
obtaining the first candidate token used for the completion on the first direction, the probability of the first candidate token, the second candidate token used for the completion on the second direction and the probability of the second candidate token by inputting the prefix-suffix fusion feature into a dual output layer of the dual decoder.

3. The method of claim 1, wherein determining the target completion direction from the first direction and the second direction based on the probability of the first candidate token and the probability of the second candidate token, comprises:
comparing the probability of the first candidate token with the probability of the second candidate token;
in response to the probability of the first candidate token being greater than the probability of the second candidate token, determining the first direction as the target completion direction;
in response to the probability of the second candidate token being greater than the probability of the first candidate token, determining the second direction as the target completion direction; or
in response to the probability of the first candidate token being equal to the probability of the second candidate token, determining at least one of the first direction or the second direction as the target completion direction.

4. The method of claim 1, wherein filling the token bit to be filled along the target completion direction with the candidate token, selected from the first candidate token and the second candidate token, corresponding to the target completion direction, comprises one of:
in response to the target completion direction being the first direction, filling a token bit to be filled after the prefix information along the first direction with the first candidate token;
in response to the target completion direction being the second direction, filling a token bit to be filled before the suffix information along the second direction with the second candidate token; or
in response to the target completion direction comprising the first direction and the second direction, filling the token bit to be filled after the prefix information along the first direction with the first candidate token, and filling the token bit to be filled before the suffix information along the second direction with the second candidate token.

5. The method of claim 4, comprising one of:
in response to the target completion direction being the first direction, after filling a corresponding token bit to be filled with the first candidate token, keeping the suffix information unchanged, taking a combination of the prefix information and the first candidate token as new prefix information, and performing a predicting on a next token bit to be filled based on the new prefix information and the suffix information;
in response to the target completion direction being the second direction, after filling a corresponding token bit to be filled with the second candidate token, keeping the prefix information unchanged, taking a combination of the suffix information and the second candidate token as new suffix information, and performing a prediction on a next token bit to be filled based on the new suffix information and the prefix information; or
in response to the target completion direction comprising the first direction and the second direction, after filling corresponding token bits to be filled with the first candidate token and the second candidate token respectively, taking a combination of the prefix information and the first candidate token as new prefix information, taking a combination of the suffix information and the second candidate token together as new suffix information, and preforming a prediction on a next token bit to be filled based on the new prefix information and the new suffix information.

6. The method of claim 1, further comprising:
after token bits to be filled between the prefix information and the suffix information are filled to obtain completed information, removing a token that meets a removal condition from the completed information, wherein the removal condition is determined based on at least one of a pre-configuration or the original input information.

7. A method for training an information completion model, comprising:
obtaining training sample data;
obtaining prefix information and suffix information from the training sample data;
obtaining a first candidate token used for a completion on a first direction and a second candidate token used for the completion on a second direction by inputting the prefix information and the suffix information into an information completion model to perform a completion prediction on the training sample data, wherein a structure of the information completion model is a dual-decoding two-tower information completion deep learning model structure;
determining a model loss value based on a real token after the prefix information in the training sample data, a real token before the suffix information in the training sample data, the first candidate token and the second candidate token; and
training the information completion model based on the model loss value.

8. The method of claim 7, wherein determining the model loss value based on the real token after the prefix information in the training sample data, the real token before the suffix information in the training sample data, the first candidate token and the second candidate token, comprises:
determining a first loss value base on the real token after the prefix information in the training sample data and the first candidate token;
determining a second loss value based on the real token before the suffix information in the training sample data and the second candidate token; and
determining the model loss value based on the first loss value and the second loss value.

9. The method of claim 7, wherein the information completion model at least comprises a prefix encoder, a suffix encoder and a dual decoder, a network structure of the prefix encoder and a network structure of the suffix encoder are both encoders in a Transformer model, and the dual decoder is a decoder in the Transformer model with an output layer being changed to a dual output layer.

10. An electronic device, comprising:
at least one processor; and
a memory communicatively connected to the at least one processor;
wherein the memory stores instructions executable by the at least one processor, and the at least one processor is configured to:
obtain, for information to be completed, prefix information and suffix information from original input information;
obtain a first candidate token used for a completion on a first direction, a probability of the first candidate token. a second candidate token used for the completion on a second direction and a probability of the second candidate token, by performing a completion prediction on the information to be completed using a preset information completion model based on the prefix information and the suffix information, wherein a structure of the information completion model is a dual-decoding two-tower information completion deep learning model structure;
determine a target completion direction from the first direction and the second direction based on the probability of the first candidate token and the probability of the second candidate token; and
fill a token bit to be filled along the target completion direction with a candidate token, selected from the first candidate token and the second candidate token, corresponding to the target completion direction.

11. The electronic device of claim 10, wherein the at least one processor is configured to:
obtain a prefix feature by encoding the prefix information based on a prefix encoder in the information completion model;
obtain a suffix feature by encoding the suffix information based on a suffix encoder in the information completion model;
obtain a prefix-suffix fusion feature by fusing the prefix feature and the suffix feature based on a dual decoder in the information completion model; and
obtain the first candidate token used for the completion on the first direction, the probability of the first candidate token, the second candidate token used for the completion on the second direction and the probability of the second candidate token by inputting the prefix-suffix fusion feature into a dual output layer of the dual decoder.

12. The electronic device of claim 10, wherein the at least one processor is configured to:
compare the probability of the first candidate token with the probability of the second candidate token;
in response to the probability of the first candidate token being greater than the probability of the second candidate token, determine the first direction as the target completion direction;
in response to the probability of the second candidate token being greater than the probability of the first candidate token, determine the second direction as the target completion direction; or
in response to the probability of the first candidate token being equal to the probability of the second candidate token, determine at least one of the first direction or the second direction as the target completion direction.

13. The electronic device of claim 10, wherein at least one processor is configured to perform one of:
in response to the target completion direction being the first direction, filling a token bit to be filled after the prefix information along the first direction with the first candidate token;
in response to the target completion direction being the second direction, filling a token bit to be filled before the suffix information along the second direction with the second candidate token; or
in response to the target completion direction comprising the first direction and the second direction, filling the token bit to be filled after the prefix information along the first direction with the first candidate token, and filling the token bit to be filled before the suffix information along the second direction with the second candidate token.

14. The electronic device of claim 13, wherein the at least one processor is configured to perform one of:
in response to the target completion direction being the first direction, after filling a corresponding token bit to be filled with the first candidate token, keeping the suffix information unchanged, taking a combination of the prefix information and the first candidate token as new prefix information, and performing a predicting on a next token bit to be filled based on the new prefix information and the suffix information;
in response to the target completion direction being the second direction, after filling a corresponding token bit to be filled with the second candidate token, keeping the prefix information unchanged, taking a combination of the suffix information and the second candidate token as new suffix information, and performing a prediction on a next token bit to be filled based on the new suffix information and the prefix information; or
in response to the target completion direction comprising the first direction and the second direction, after filling corresponding token bits to be filled with the first candidate token and the second candidate token respectively, taking a combination of the prefix information and the first candidate token as new prefix information, taking a combination of the suffix information and the second candidate token together as new suffix information, and preforming a prediction on a next token bit to be filled based on the new prefix information and the new suffix information.

15. The electronic device of claim 10, wherein the at least one processor is configured to:
after token bits to be filled between the prefix information and the suffix information are filled to obtain completed information, remove a token that meets a removal condition from the completed information, wherein the removal condition is determined based on at least one of a pre-configuration or the original input information.

16. An electronic device, comprising:
at least one processor; and
a memory communicatively connected to the at least one processor;
wherein the memory stores instructions executable by the at least one processor, and the at least one processor is configured to perform the method of claim 7.

17. The electronic device of claim 16, wherein the at least one processor is configured to:
determine a first loss value base on the real token after the prefix information in the training sample data and the first candidate token;
determine a second loss value based on the real token before the suffix information in the training sample data and the second candidate token; and
determine the model loss value based on the first loss value and the second loss value

18. The electronic device of claim 16, wherein the information completion model at least comprises a prefix encoder, a suffix encoder and a dual decoder, a network structure of the prefix encoder and a network structure of the suffix encoder are both encoders in a Transformer model, and the dual decoder is a decoder in the Transformer model with an output layer being changed to a dual output layer.

19. A non-transitory computer readable storage medium having computer instructions stored thereon, wherein the computer instructions are used to cause a computer to perform the method of claim 1.

20. A non-transitory computer readable storage medium having computer instructions stored thereon, wherein the computer instructions are used to cause a computer to perform the method of claim 7.
